(19) United States
(12) Patent Application Publication
(10) Pub. No.: US 2007/0212949 A1
(43) Pub. Date: Sep. 13, 2007

(54) Plug and counterplug for an electrical contact

(75) Inventors: Ulrich Mayer, Titisee-Neustadt (DE); Peter Kazior, Rottweil-Neufra (DE); Roland Baumgaertner, Bonndorf (DE)

Correspondence Address: NATH & ASSOCIATES, PLLC, 112 South West Street, Alexandria, VA, 22314, US

(73) Assignee: IMS CONNECTOR SYSTEMS GMBH, Loffingen (DE)

(21) Appl. No.: 11/581,382

(22) Filed: Oct. 17, 2006

(30) Foreign Application Priority Data
Mar. 8, 2006 (DE) 10 2006 011 116.8

(51) Int. Cl. H01R 13/432

(52) U.S. Cl. 439/748

(57) ABSTRACT

The invention relates to a plug arrangement, with a plug (1) that has a cylindrical wall (5) for electrically contacting a counterplug (2), such that the plug wall (5) is thin enough, relative to its length (1) in the direction of insertion, for it to be mounted in elastic fashion over the cylindrical wall (15) of the counterplug (2) or inserted into the cylindrical wall of the counterplug.

The invention relates to a plug, which serves to electrically contact a counterplug and which exhibits a cylindrical wall; the invention also relates to a counterplug with a cylindrical wall which fits said plug.

It is generally known to design plugs and counterplugs for electrical contacting, with a cylindrical wall on the plug and a cylindrical wall on the counterplug. In these cases, the plug wall is designed and dimensioned so as to be pushed through or over the counterplug wall. The diameter of the plug wall and that of the counterplug wall consequently differ, in order to allow one to be pushed over the other, ideally in such a way as to provide a frictional connection between the two. However, when the plug and counterplug are frequently joined and separated, the frictional connection may be lost, with the result that the two components no longer securely lock and the electrical contact is lost.

Also generally known are plugs with a cylindrical wall exhibiting two or more longitudinal slots which run into the plug wall, proceeding from an open plug end and moving in the direction of insertion. The cylindrical plug wall can be widened in this way. This permits the creation of a cylindrical plug wall with an inner diameter that is slightly smaller than the outer diameter of the counterplug wall, with the result that the plug wall elastically widens with ease upon insertion and the counterplug wall is elastically braced in the plug wall. With this kind of design, a disadvantage rests in the fact that the shape and dimensions are very exact. Moreover, the plug wall and the counterplug wall are customarily manufactured from a solid, high-quality metal, with a thick, material-intensive wall.

The goal of the invention is to propose an alternately designed plug and counterplug for electrical contacting, in a configuration that permits both a simple manufacturing process and a low material requirement.

This goal is achieved by a plug with the features of patent claim 1 and, in conjunction with such a plug, by a counterplug with the features of patent claim 6. Advantageous embodiments are the subject matter of the dependent claims.

Preferred, therefore, is a plug for electrical contacting that exhibits a cylindrical plug wall, such that only a single slot running from the open end of the plug into the plug is applied to the cylindrical wall; and/or such that at least one embossed area is applied to the cylindrical plug, which embossed area protrudes toward the counterplug wall when the unit is in its assembled state.

Ideally the plug wall will be thin enough, relative to its length in the direction of insertion, for it to be mounted in elastic fashion over the cylindrical wall of the counterplug or inserted into the cylindrical wall of the counterplug. The essential role is played the wall's thinness, which provides the cylindrically designed plug wall with sufficient elasticity or spring-like properties. The electrical contact, and ideally, too, the mechanical friction connection, thus arise from the special geometry and shape of the cylindrical plug wall.

This kind of design advantageously permits the cylindrical wall to be closed all around its circumference on its open end (i.e., it does not have a slot running into the plug wall), since a sufficient degree of elasticity is provided by the thinness of the wall. Preferred, however, is an initial and independently advantageous embodiment with only a single slot, which runs from the open end of the plug into the plug, in the direction of insertion. In order to additionally increase the elasticity of this system of plug and counterplug, only a single slot is necessary, and this represents a marked difference from known geometries, where a plurality of slots is applied along the axis of insertion and whose result is a number of individual, independently functioning spring arms. A design that specifies only a single slot is made possible by the elasticity of the material at the circumference. Here the circumferential length is the effective bending arm, both for a design without a slot and for one exhibiting a single slot.

In the cylindrical wall of a second and also independently advantageous design, a beneficial feature is provided by at least one and ideally several embossed areas that protrude in the direction of the counterplug wall and guarantee a secure electrical contact. Ideally these small embossed areas will be distributed around the circumference of the thin-walled cylinder wall. When the plug wall is externally mounted over the counterplug, the embossed areas protrude inwardly from the plug wall. When the plug wall is inserted into the counterplug, the embossed areas protrude in the outward direction.

Particularly preferred is an embodiment in which the counterplug with a cylindrical wall has a groove or channel to serve as a locking element for at least one embossed area in the plug wall protruding toward the counterplug wall. This provides not only a good electrical contact between the plug and the counterplug, but also a good mechanical contact. Without this kind of circumferential groove the counterplug is still able to provide the advantage of sufficient contact, but the plug and counterplug are given a sliding design rather than a locking or snapping one.

A counterplug with a cylindrical wall to be inserted into, or slipped over, the cylindrical wall of a corresponding plug has a particularly advantageous design when the cylindrical counterplug wall is closed in circular fashion on its open end; the counterplug wall then has mechanical stability, despite its thin-walled design. At the same time, this circular counterplug wall will provide a mechanically stable counter-bearing for the cylindrical wall of the plug, with the result that the cylindrical wall of the plug itself has a mechanically stable support, despite its thinness.

In contrast to conventional plugs with thick walls, this small wall thickness makes it possible to employ the deep-drawing process, and this in turn provides a savings in material. Thus these plug and counterplug walls can be produced simply and cost-effectively with the deep-drawing process.

Advantages are therefore conferred by the use of deep-drawing technology, by a design that eliminates a slot, or provides for only a single slot, and by a reduced material requirement permitting the use of economic materials.

An exemplary embodiment is next described in greater detail on the basis of the drawing, which shows:

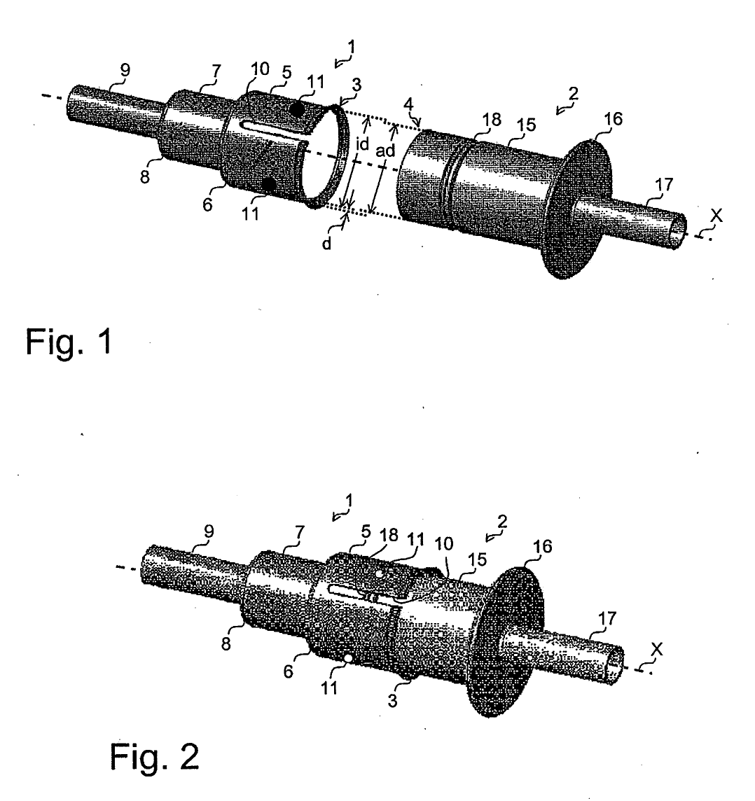

FIG. 1 a perspective view of a plug and counterplug, in separated state

FIG. 2 the plug and counterplug in assembled state

FIGS. 1 and 2 depict a plug 1 and a counterplug 2, which can be plugged together in the axial direction along their longitudinal axes X using the open plug end 3 and the open plug end 4. The plug connection involved is a detachable one.

The material used for the depicted components is an electrically conductive metallic one. Shown here are the metal components for the contact in this kind of plug configuration. In principle, other contacts can be formed using additional contact elements that fit on the inside or are fitted on the outside. Usually (but not necessarily) this kind of plug arrangement, consisting of a plug 1 and a counterplug 2, is encompassed by a plastic housing at the rear end of the given component.

In the preferred embodiment the plug 1 and/or the counterplug 2 are formed of metallic material using the deep-drawing process. In this process, gradations are formed in the cylindrically symmetrical circumference of the plug 1 and the counterplug 2. The use of the deep-drawing process is made possible specifically by the very thin-walled design of the cylindrical sections of the plug 1 and the counterplug 2. A thin-walled design is understood here as a wall thickness d relative to the length 1 of the given wall.

A front section of the plug 1, cylindrically shaped on the open plug end 3, forms a cylindrical plug wall 5. The cylindrical plug wall 5 is designed to have a thin wall thickness d relative to the length 1 in the axial direction of the cylindrical plug wall 5. At the back of the cylindrical plug wall 5—i.e., away from the mountable or insertable counterplug 5—the cylindrical plug wall 5 passes over a tapered step 6 into a central section 7, which is designed to receive an inner plug, insulating part, or other components. The central section 7 passes over another tapered step 8 and into a tubular cylindrical connecting section 9 at the back, which is intended for connecting a cable. At the back, the end of an uninsulated cable can be introduced into a hole in the connecting section 9, and clamped there or soldered into place. It is also possible to lead a shielded and/or insulated cable through the connecting section 9 up to the central section 7 and/or the area within the cylindrical plug wall 5, in order to create an inner contact.

In producing an embodiment of this kind, where the plug I has several steps 6, 8 and sections 5, 7, 9, the deep-drawing process can be employed to advantage. In principle, however, other embodiments can be provided, e.g., one in which only a front cylindrical section creates the plug wall 5, without a central section 7 behind the plug wall 5 and/or a rear connecting section 9.

Given a thin-walled design, ideally one with a wall thickness d of less than 0.5 mm, the cylindrical plug wall 5 will display sufficient elasticity, even without a slot, for it be pushed over an appropriately dimensioned cylindrical counterplug wall 15. Preferred, however, is a design with only a single slot 10, which runs toward the back from the open plug end 3 in the cylindrical plug wall. Due to the thin-walled design of the cylindrical plug wall, this single slot 10 will provide an advantageous increase in the elasticity of the entire plug arrangement.

In another advantageous embodiment, the cylindrical plug wall exhibits embossed areas 11 which are so designed that they protrude slightly toward the counterplug 15 when the configuration is in its assembled state. These embossed areas 11 provide a particularly good contact when acting in conjunction with the elastic properties of the cylinder created by the plug wall 5. In the depicted embodiment of a cylindrical plug wall 5, which is mounted around the counterplug 15, the embossed areas 11 thus protrude in the inward direction.

The counterplug 2 will also consist by preference of a deep-drawn metallic element in the front cylindrical section (i.e., the cylindrical section facing the plug 1) comprising the counterplug wall 15. Behind the counterplug wall 15, i.e., running away from the plug 1 in the axial direction, the counterplug wall 15 passes over an outwardly projecting flange 16 and into a connecting section 17 at the rear. The flange 16 can take the form of a stop. The connecting section 17 serves the purpose of introducing and contacting and/or guiding a connecting cable.

In a preferred and advantageous embodiment a circular groove or channel 18 is formed in the cylindrical counterplug wall 15, and this groove or channel 18 serves as a locking element or catch for the embossed areas 11 belonging to the plug 1, or for at least a portion of those embossed areas 11. The groove 18 can also be formed to advantage as an embossed area. In particular, the groove can be only a partial one, or one formed of several sections, instead of being continuous over the entire circumference.

The cylindrical counterplug wall 15 can also be advantageously formed by a thin-walled material, thereby permitting simple and economical production in the deep-drawing process. In particular, a more cost-effective material can be chosen for manufacturing this configuration of plug and counterplug.

The dimensions of the cylindrical plug wall 5 relative to the cylindrical counterplug wall 15 are selected in such a way that an inner diameter ‘id’ of the cylindrical plug wall 5 is equal to or slightly greater than the outer diameter ‘ad’ of the cylindrical counterplug wall 15. This allows the two parts to initially move one inside the other without friction, which is desirable. The force of contact and degree of fit are so adjusted by the depth of the embossed areas 11, in conjunction with the wall thickness d, that there is a sufficient degree of mechanical and electrical contact. Conventional insertion and pulling forces of about 5 to 40 N are advantageously established.

Particularly advantageous is the flexible contact area, which receives its flexibility from the circumference of the cylinder, i.e., from the cylindrical plug wall 5. Here the circumferential length is the effective bending arm, both in a configuration without any slot and in a configuration with a single slot 10. In the case of a plug that is mounted on the outside, an advantage is conferred if the open plug end 3 is bent outward slightly. This facilitates the insertion of the open end 4 of the counterplug 2.

The flexibility of the cylindrical plug wall 5 in the embodiment without a slot is determined by the embossed areas and the wall thickness d, as well as by the elastic properties of the material employed. This unslotted cylindrical plug wall creates a spring-action or elastic effect in combination with the embossed areas 11 that take the form of contact points. With the embossed areas 11 protruding inward toward the counterplug wall 15, the cylinder forming the plug wall is slightly deformed, or becomes slightly noncircular. In the insertion process, the counterplug 2 pushes the deformed cylinder back into its original position, at least to a degree.

When narrow tolerances are observed it is possible to maintain the customary insertion and pulling forces of about 5-40 N, since the bending arms of conventionally tab-shaped plug elements are shortened in the direction of insertion to the distance between the embossed areas 11. With the preferred single slot 10, the entire circumference of the cylindrical plug 5 becomes a bending arm, with the result that there is a greater degree of elasticity, along with an improved adjustment to the desired forces at work.

Thus, in the design of the cylindrical plug wall 5, the preferred elements of the plug configuration, and particularly of the corresponding plug 1, are small embossed areas 11 and/or a slot 10, taken either individually or, preferably, in combination with a thin-walled cylinder.

Small embossed areas 11 in the plug wall 5 are ideally distributed over the circumference. These embossed areas 11 represent preferred contact points and may also be used as catches when the counterplug 2 exhibits a matching groove or channel 18.

For this function, a certain elasticity or spring action is required in the cylinder, which is formed by the plug wall 5. In contrast to known geometries—in which a plurality of slots is applied in the direction of the axis of insertion X, with the result that there are individual, independently functioning spring arms—the preferred plug arrangement exploits the elasticity of the material in the circumferential area of the plug wall 5. In order to additionally increase the spring action of this system, a single slot 10 is advantageously applied to the plug wall 5.

Particularly preferred is a thin-walled plug wall 5 with a wall thickness d that is small in comparison to the length 1 of the corresponding section. In the area of reduced stress, a wall thickness d that smaller than 0.5 mm, particularly smaller than 0.25 mm, is ideal, and the length of the section will ideally be larger than 0.5 cm, and particularly larger than 0.75 cm.

1. Plug (1) with a cylindrical wall (5) for electrically contacting the wall (15) of the counterplug (2),
wherein
only a single slot (10) is formed in the cylindrical plug wall (5), which slot (10) runs back from the open plug end (3), and/or at least one embossed area (11) is formed in the cylindrical plug wall (5), which embossed area (11) protrudes toward the counterplug wall (15) when the unit is in assembled condition.

2. Plug according to claim 1,
wherein
the plug wall (5) is thin enough, relative to its length (1) in the direction of insertion, to be mounted in elastic fashion over the cylindrical wall (15) of the counterplug (2) or inserted into the cylindrical wall (15) of the counterplug (2).

3. Plug according to claim 1,
wherein
the cylindrical plug wall (5) is closed around the circumference of one open end (3) of said plug (5).

4. Plug according to claim 1,
wherein
the cylindrical plug wall (5) and/or the sections behind it are formed by deep-drawing.

5. Plug according to claim 1,
wherein
a wall thickness (d) of the cylindrical plug wall (5) is thin in design, at least in the direction of the open plug end (3), and has a thickness (d) less than 0.5 mm and particularly less than 0.25 mm, and the length (1) of the cylindrical plug wall (5) is greater than 5 mm in the direction parallel to its axis, and particularly greater than 7.5 mm.

6. Counterplug (2) with a cylindrical wall (15) for insertion into or mounting onto the cylindrical plug wall (5) of a plug (1) according to claim 1,
wherein
the cylindrical counterplug wall (15) is circumferentially sealed on its the open end (4).

7. Counterplug according to claim 6,
wherein
a circumferential groove (18) is applied to the counterplug wall (15) as a locking element for at least one embossed area (11) in the plug wall (5), which embossed area (11) protrudes toward the counterplug wall (15) when the unit is in assembled condition.
